(19) United States
(12) Patent Application Publication
(10) Pub. No.: US 2009/0095823 A1
(43) Pub. Date: Apr. 16, 2009

(54) Multiple stage flow amplification and mixing system

(75) Inventors: Thomas Gardega, Conway, SC (US); Abdel N. Bacchus, Richmond Hill, NY (US)

Correspondence Address: DILWORTH & BARRESE, LLP, 333 EARLE OVINGTON BLVD., SUITE 702, UNIONDALE, NY, 11553, US

(73) Assignee: XIOM CORPORATION, West Babylon, NY (US)

(21) Appl. No.: 12/286,161

(22) Filed: Sep. 29, 2008

Related U.S. Application Data
(60) Provisional application No. 60/996,000, filed on Sep. 28, 2007.

(51) Int. Cl. B05B 7/24; B05B 7/32

(52) U.S. Cl. 239/419.3; 239/419; 239/419.5; 239/422; 239/427.5

(57) ABSTRACT

A fluid amplification and mixing device is provided, which includes a siphon plug defining a first portion of a passageway being configured to receive a first fluid. The siphon plug further defines at least one opening configured to receive a second fluid in communication with the passageway. A venturi defines a second portion of the passageway for receiving a mixture of the first and second fluids. The venturi further defines an input port configured to receive a third fluid and at least one accelerator chamber communicating with the input port and the second portion of the passageway. A siphon barrel defines a third portion of the passageway being configured to receive a mixture of the first, second and third fluids and supply the mixture to a combustion chamber thereof.

### CROSS-REFERENCE TO RELATED APPLICATION

The present application claims the benefit of U.S. Provisional Application Ser. No. 60/996,000 filed Sep. 28, 2007, which is herein incorporated by reference in its entirety.

### BACKGROUND

1. Field of the Invention

The present invention is generally related to fluid flow amplification devices configured to increase fluid velocity through a defined orifice in a defined path. In particular, the present invention is related to a multiple stage flow amplification and mixing system designed to increase directed fluid flow using a single fluid or a mixture of fluids.

2. Background of the Art

The Coanda effect as used in airflow amplifiers to achieve high amplification ratios is well known. The Coanda effect involves discharging a small volume of fluid (primary fluid) under high velocity from a nozzle, the nozzle being immediately adjacent a shaped surface. The primary fluid tends to follow the shaped surface and as it does so it induces surrounding fluid (secondary fluid) to flow with it. This can also be used in an airflow amplifier. In an airflow amplifier, a small volume of primary fluid is therefore used to move a much larger volume of secondary fluid, the amplification ratio being the total volume of primary and secondary fluid discharged from the device in relation to the volume of primary fluid supplied.

Other types of fluid moving devices are also available on the market today but, each has different types of problems associated with them. These devices are sometimes referred to as ejectors. In general, such ejectors have been used to create relatively high suction and have therefore been used effectively as pumps. Characteristically, such ejectors are capable of only limited airflow amplification but that failing is not of major concern in a device intended primarily to generate high suction. Where high amplification has been required, Coanda-type amplifiers have been available and have generally been regarded as more effective for achieving high amplification ratios.

Unfortunately, airflow amplifiers that operate on the Coanda principle do have certain disadvantages. Since some of the kinetic energy in the primary stream is used to turn that stream (and also a part of the secondary stream), the Coanda profile is machined carefully for optimum performance. Also, Coanda amplifiers are particularly sensitive to back pressure at the outlet and, as this pressure is increased, it can cause a sudden detachment of the primary stream from the profile, resulting in turbulence and flow reversal in the suction inlet area. This event is especially dangerous if the amplifier is using two different types of gases and one of the gases is combustible. That is, once the combustible gas combines with the increased airflow from the atmosphere it has enough oxygen to be combusted. Flow amplifiers that can backflow may cause the device being used with the airflow amplifier to inflame. Efforts to reduce the flow reversal characteristics, so that reversal occurs only at higher exit pressures, have had the effect of substantially reducing the amplification ratios (see, for example, U.S. Pat. No. 3,801,020).

Therefore, it would be desirable to provide multiple stage fluid flow amplification and mixing device that can safely increase the fluid flow in a device with a reduced risk of flow reversal. The multiple stage flow amplification and mixing device of the present invention described in further detail below and in the figures benefits from several advantages, which may overcome many, if not all of the shortcomings of the prior art.

### SUMMARY OF THE INVENTION

The present invention is directed to multiple stage flow amplification and mixing device that effectively and precisely increases fluid flow of a device several times the original rate of flow to overcome the disadvantages and drawbacks of the prior art.

In one embodiment, the present invention is configured to significantly increase the flow of air through the device without increasing the risk of reversal of flow. This allows the device to be safely used with combustible gases without the risk of exploding or inflame. In another embodiment, the device is configured to mix atmospheric gases, including oxygen, with combustible gases, like propane, which enriches the mixture with oxygen and allows it to burn quicker and at a higher temperature. In another embodiment, the device is configured to amplify the airflow without having to provide pressurized gases at each stage of the device. The device provides a pressurized gas flow, which may be obtained without the need of additional pressurized connections at each stage of the amplification.

In one particular embodiment, in accordance with the principles of the present disclosure, a fluid amplification and mixing device is provided. The fluid amplification and mixing device includes a siphon plug, which defines a first portion of a passageway that is configured to receive a first fluid. The siphon plug further defines at least one opening configured to receive a second fluid in communication with the passageway. A venturi defines a second portion of the passageway for receiving a mixture of the first and second fluids. The venturi further defines an input port configured to receive a third fluid and at least one accelerator chamber communicating with the input port and the second portion of the passageway.

A siphon barrel defines a third portion of the passageway, which is configured to receive a mixture of the first, second and third fluids and supply the mixture to a combustion chamber thereof.

The siphon plug may define a plurality of openings configured to receive the second fluid. The plurality of openings may be circumferentially disposed about an outer surface of the siphon plug. The siphon plug can include an inlet for receiving the first fluid at a first velocity. The inlet communicates with an accelerator that is configured to restrict the first fluid such that the first fluid exits at a second velocity greater than the first velocity. The first fluid can include compressed air. The second fluid can include atmospheric air.

The accelerator chamber can be configured to induce a siphon of the mixture of the first and second fluids received through an inlet of the venturi into a mixture of the first, second and third fluids such that the mixture of the first, second and third fluids exit the venturi. The third fluid can include a combustible gas. The venturi may define a plurality of accelerator chambers communicating with the input port and the second portion of the passageway. The venturi may define a plurality of accelerator chambers, each separately and in parallel communicating with the input port and the second portion of the passageway.

The siphon barrel may include at least one port configured to receive atmospheric air. The siphon barrel can include a plurality of ports configured to receive atmospheric air.

In an alternate embodiment, the fluid amplification and mixing device includes a first stage including an accelerator configured to restrict a volume of compressed air input to the accelerator at a first velocity such that the air exits the accelerator at a second velocity greater than the first velocity. A second stage includes a venturi connected to the accelerator to receive the air at the second velocity in a mixture with an input gas supplied at a third velocity and amplify velocity of a mixture of the air and the input gas. A third stage includes a siphon barrel configured to receive the mixture of the air and the input gas from the second stage for combustion thereof.

The first stage can be configured to receive atmospheric air in a mixture with the air exiting the accelerator. The venturi may be configured to induce a siphon of the air received from the first stage into a mixture with the input gas including a fuel such that the mixture of the air and the fuel exits the venturi at an amplified velocity. The fuel may include propane. The siphon barrel can be configured to receive atmospheric air in a mixture with the air and the input gas.

In another embodiment, a fluid amplification and mixing system is provided, which is adapted for use with a powder sprayer. The system includes at least one fluid amplification and mixing device, similar to those described herein. A powder sprayer having a tip defines an axis and is configured to emit powder toward a substrate. The substrate is disposed adjacent to the at least one fluid amplification and mixing device such that the flame is directed at an angle in a range of 8 to 90 degrees from the axis of the tip and the flame is spaced apart from the powder being emitted. Alternatively, the system may include a pair of fluid amplification and mixing devices mounted to bracket with the powder sprayer and spaced equidistantly there apart. The flame may be directed at an angle of 30 degrees from the axis of the tip.

### BRIEF DESCRIPTION OF THE DRAWINGS

The present disclosure will become more readily apparent from the specific description accompanied by the following drawings, in which:

FIG. 1 is a side view of one particular embodiment of a fluid amplifier and mixing device in accordance with the principles of the present disclosure;

FIG. 2 is a rear view of the device shown in FIG. 1;

FIG. 3 is a front view of the device shown in FIG. 1;

FIG. 4 is a side cross section view of a siphon plug of the device shown in FIG. 1;

FIG. 5 is a top view of the siphon plug shown in FIG. 4;

FIG. 6 is a side view, in partial cross-section, of a venturi of the device shown in FIG. 1;

FIG. 7 is a front view of the venturi shown in FIG. 6;

FIG. 8 is a side cross-section view of a siphon barrel of the device shown in FIG. 1;

FIG. 9 is a top view of the siphon barrel shown in FIG. 8; and

FIG. 10 is a top view of a fluid amplifier and mixing system adapted for use with a powder sprayer in accordance with the principles of the present disclosure.

### DETAILED DESCRIPTION OF THE INVENTION

The exemplary embodiments of the flow amplification and mixing device and methods of use disclosed are discussed in terms of fluid flow amplification devices configured to increase fluid velocity through a defined orifice in a defined path and more particularly, in terms of a multiple stage flow amplification and mixing system designed to increase directed fluid-flow using a single fluid or a mixture of fluids.

It is contemplated that the fluid flow amplification and mixing device is a multiple stage system that can increase the volume of compressed air that flows through a given port with a small input of atmospheric air via multiple stages throughout a fluid flow path of the device. It is further contemplated that the fluid amplification and mixing device increases the amount of air supplied to the device using multiple siphons. These siphons may include air siphons, such as, for example, venturi systems disposed along a flow pathway of the device, which amplify fluid flow and enrich the fluid flow with oxygen, which is beneficial for combustion. It is envisioned that the device can also be used to mix fluids with atmospheric air to enable combustion and/or increase temperature for a burning flame. Desirably, the siphons of the device include an air siphon plug, an amplification and mixing venturi and a siphon barrel.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. In the discussion herein, the term “fluid” refers to a gas, liquid and transitional phases of liquids and gases.

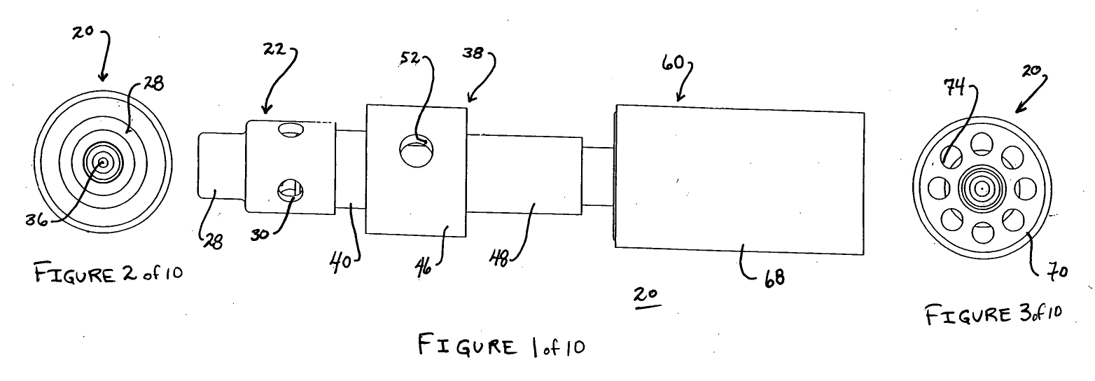

The following discussion includes a description of a fluid amplification and mixing device, related components and exemplary methods of employing the fluid amplification and mixing device in accordance with the principles of the present disclosure. Alternate embodiments are also disclosed. Reference will now be made in detail to the exemplary embodiments of the present disclosure, which are illustrated in the accompanying figures. Turning now to FIGS. 1-3, there is illustrated components of a fluid amplification and mixing device 20 in accordance with the principles of the present disclosure.

The components of fluid amplification and mixing device 20 are fabricated from materials suitable for fluid flow applications, including metals, polymers, ceramics, and/or their composites, depending on the particular application and/or preference of a user. These materials include but are not limited to aluminum, brass, bronze, stainless steel, steel, Poly Vinyl Chloride (PVC), Polyethylene (PE) Polypropylene (PP), Acrylonitrile butadiene styrene (ABS), Polytetrafluoroethylene (PTFE), Fluorinated ethylene propylene (FEP), and other polymer materials. One skilled in the art, however, will realize that such materials and fabrication methods suitable for assembly and manufacture, in accordance with the present disclosure, would be appropriate.

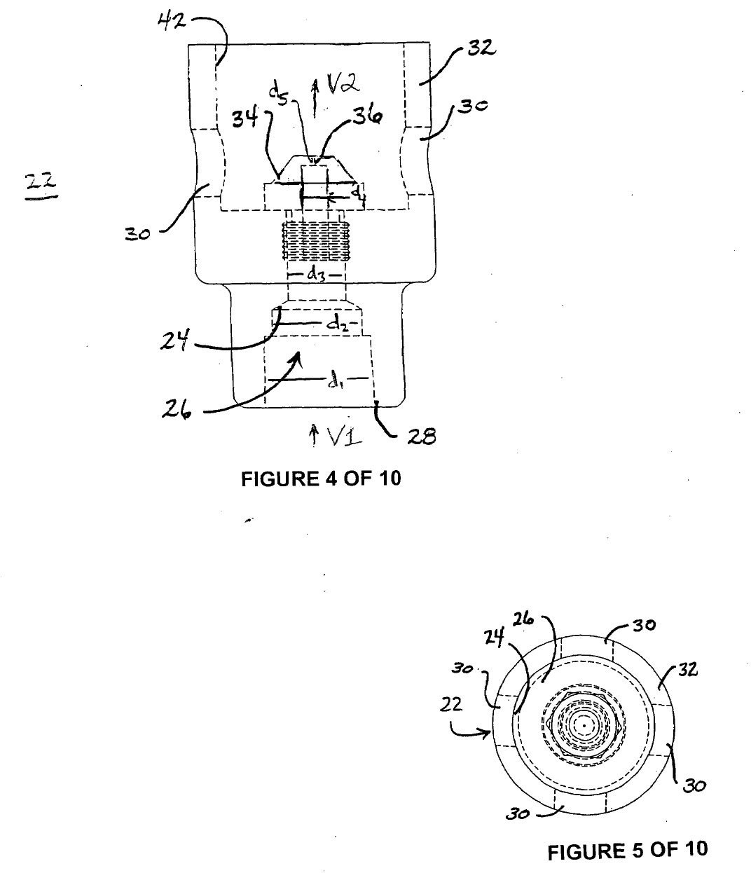

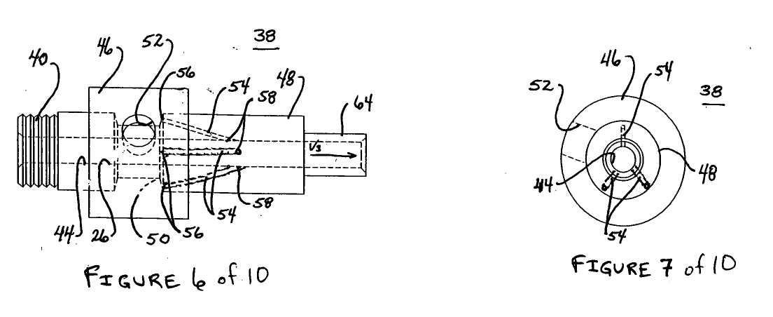

Fluid amplification and mixing device 20 includes an air siphon plug 22, which defines a first portion 24 of a fluid passageway 26, as shown in FIGS. 4 and 5. First portion 24 is configured to receive a first fluid, such as, for example, compressed air via an inlet, such as, for example, a port 28 of siphon plug 22. Port 28 is configured to receive a coupling from a compressed air supply (not shown). Port 28 has a plurality of stepped or inner concentric sections for receiving the compressed air and an air coupling. It is contemplated that port 28 may have various geometric configurations, such as, polygonal, circular, elliptical and spiral. It is further contemplated that port 28 may include couplings such as a quick release, threaded, clip, pressure and monolithic. It is envisioned that the first fluid may include alternative gases, liquids, and combinations thereof, including atmospheric air and fuels, such as but not limited to nitrogen, argon, helium, oxygen, air propane, propylene, map, browns gas, apache, LPG, CO2, kerosene, fuel oil, JP5, JP6, chemicals of all types, and other liquids and gases not enumerated.

Siphon plug 22 defines openings 30 spaced equidistantly about a circumference of a body 32. Openings 30 are configured to receive a second fluid, as such, for example, atmospheric air for communication with passageway 26. It is contemplated that openings 30 may be variously configured such as circular, elliptical and polygonal, depending on the volume and direction of fluid flow required for a particular application. It is further contemplated that siphon plug 22 may include one or a plurality of openings 30, which can be variously disposed about body 32. It is envisioned that the second fluid may include alternative gas, liquids or combinations thereof, such as but not limited to nitrogen, argon, helium, oxygen, air propane, propylene, map, browns gas, apache, LPG, CO₂, kerosene, fuel oil, JP5, JP6, chemicals of all types, and other liquids and gases not enumerated

Siphon plug 22 includes port 28 for receiving compressed air at a first velocity v. Port 28 communicates through first portion 24 with a siphon port 34. Siphon port 34 includes an accelerator 36 configured to restrict the flow of compressed air such that the compressed air exits siphon port 34 at a second velocity v₂, greater than first velocity v₁. Port 28 has a first diameter d₁, which reduces with the concentric, stepped sections of diameters d₂, d₃, d₄ as air passes through passageway 26. Accelerator 36 has a diameter d₅, which substantially reduces the diameter of passageway 26 and increases the velocity of compressed air passing there through. The increased velocity of the compressed air creates a siphon effect to draw atmospheric air through openings 30. This creates a higher velocity mixture of compressed air and atmospheric air in passageway 26 to be supplied to a venturi 38 of device 20. The measurement of d₅ is about 0.005 inch to about 0.05 inch, preferably about 0.01 inch to about 0.03 inch, and more preferably about 0.020 inch.

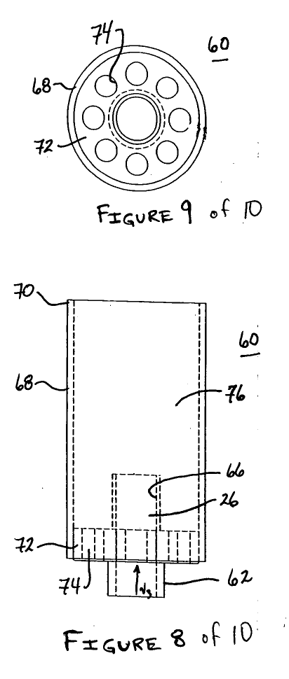

Referring to FIGS. 6 and 7, venturi 38 is coupled to siphon plug 22 via threaded engagement with a threaded first end 40 and an inner surface 42 of body 32. It is contemplated that venturi 38 may be coupled to siphon plug 22 with alternative structure such as, quick release coupling, clips, pressure mount or monolithically formed therewith.

Venturi 38 defines a second portion 44 of passageway 26 for receiving the mixture of compressed air and atmospheric air from siphon plug 22. Venturi 38 includes a member 46, disposed with first end 40 and a second end 48 of venture 38. Member 46 may be fixed with venturi 38, or alternatively, may be removable, relatively rotatable or relatively slidable therewith.

Member 46 defines a chamber 50 and an input port 52 communicating therewith. Input port 52 is configured to receive a third fluid, such as, for example, a propane fuel for flow within chamber 50. Input port 52 is configured to receive a coupling from a fuel supply (not shown). It is contemplated that input port 52 may have various geometric configurations, such as, polygonal, circular and elliptical. It is further contemplated that input port 52 may include couplings such as quick release, threaded, clips, pressure and monolithic. It is envisioned that the third fluid may include alternative fuel and/or fluid mixtures, including oxygen and/or air, such as but not limited to nitrogen, argon, helium, oxygen, air propane, propylene, map, browns gas, apache, LPG, CO₂, kerosene, fuel oil, JP5, JP6, chemicals of all types, and other liquids and gases not enumerated. It is further envisioned that chamber 50 may be variously configured and dimensioned including sections, vanes, fluid flow scoops or other structure to facilitate fluid flow according to the particular volume, velocity and/or mixture requirements of a fluid flow application.

Second end 48 defines accelerator chambers 54, which communicate with chamber 50 for receiving the flow of fuel therefrom. Accelerator chambers 54 extend from an inlet 56 adjacent chamber 50 to an outlet 58 at second portion 44 along the length of second end 48. Accelerator chambers 54 are configured to restrict the flow of fuel to increase the velocity of the fuel flow for introduction to passageway 26 and the corresponding air flow mixture passing there through. The diameter of chamber 54 is about 0.005 to about 0.05 inch, preferably about 0.010 to about 0.040 inch and more preferably about 0.037 inch. The increased velocity fuel stream is supplied to second portion 44 and received by the airflow mixture such that the velocity is increased and the fuel stream mixes with the airflow. Thus, a mixture of compressed air, atmospheric air and fuel are amplified to a higher third velocity v₃, which exits venturi 38 via passageway 26 to be supplied to a siphon barrel 60 of device 20.

It is contemplated that venturi 38 may include one or a plurality of accelerator chambers 54. Accelerator chambers 54 may be variously configured and dimensioned including tapering diameter, alternate sized diameter along the length or between chambers, alternate chamber length or geometric cross-section. Accelerator chambers 54 may be parallel, offset, tapered, non-parallel, staggered and accurate including portions thereof.

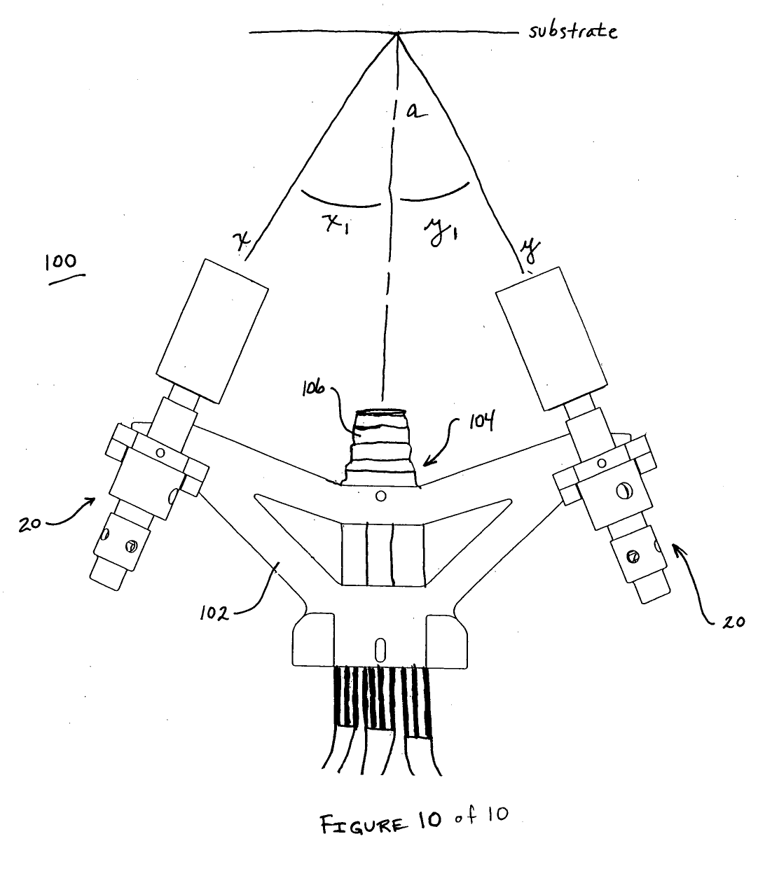

Referring to FIGS. 8 and 9, siphon barrel 60 has a first end 62 that couples to a coupling portion 64 of second end 48. First end 62 may be fixed with coupling portion 64, or alternatively, may be removable, relatively rotatable or relatively slidable therewith. Siphon barrel 60 defines a third portion 66 of passageway 26. Third portion 66 is configured to receive the mixture of air and fuel at velocity v₃. Siphon barrel 60 has a body 68 that extends to a second open end 70. First end 62 has a cylindrical disc 72, which defines openings, such as, for example, siphon ports 74. The mixture travels through passageway 26 into a combustion chamber 76 defined by body 68 toward open end 70. Siphon ports 74 are spaced equidistantly about disc 72 and are configured to receive atmospheric air for communication with passageway 26.

The mixture traveling through passageway 26 at the higher velocity v₃ creates a siphon effect to draw atmospheric air through siphon ports 74 and into the mixture, such that a high volume, high velocity mixture of air and fuel is created to produce a clean combustible fluid mixture suitable for continuous clean combustion. It is contemplated that siphon ports 74 may be variously configured and dimensioned such as circular, elliptical and polygonal, depending on the volume and direction of fluid flow required for a particular application. It is further contemplated that siphon barrel 60 may include one or a plurality of siphon ports 74, which can be variously disposed about body 68.

In one particular embodiment of use, fluid amplification and mixing device 20 receives air into siphon plug 22 via a compressed accelerated air system (not shown). Passageway 26 siphons additional air from the environment adjacent device 20, for example, atmospheric air, such that the flow of air that exits open end 70 of siphon barrel 60 has a volume and velocity that are increased over the compressed air entering port 28. Siphon barrel 60 can be configured as a combustion nozzle such that an enriched mixed fluid flow is combusted. The design and structure of device 20 advantageously prevents flow reversal and back flashing of combustion, including the flame.

In one embodiment, device 20 is a multiple stage fluid amplification and mixing apparatus. In a first stage, device 20 includes an accelerator 36 configured to restrict a volume of compressed air, which is initially received through port 28. The compressed air is received by accelerator 36 at velocity v₁ such that the compressed air is restricted, as discussed, and the air exits accelerator 36 at velocity v₂, which is greater.

Siphon plug 22 includes openings 30, which may be drilled around its diameter to siphon in atmospheric air. Port 28 allows for the input of a volume of compressed air, which passes through air accelerator 36 and creates the siphon affect. Siphon port 34 can range in diameter from about 0.10 inches to about 0.9 inches depending on the size and the amount of air to be siphoned. It is envisioned that larger embodiments of device 20 can have siphon ports as large as several inches. Siphon port 34 can be about 0.250 inches in diameter. Air accelerator 36 has a diameter smaller than the diameter of siphon port 34. Accelerator 36 can have a diameter that ranges from about 0.05 inches to about 0.8 inches. Preferably, air accelerator 36 has a diameter of about 0.020 inches in diameter.

Air accelerator 36 is designed to restrict the volume of compressed input air that enters siphon plug 22 at port 28, which in effect increases the velocity in which the compressed air exits the air accelerator region. That is, the velocity after air exits the air accelerator 36 is higher than when it entered the accelerator. The first stage includes the described amplification process in siphon plug 22.

In a second stage, device 20 includes venturi 38 connected to accelerator 36, which receives the air at velocity v₂ in a mixture with fuel supplied at velocity v₃, thereby amplifying the velocity of the mixture of air and fuel. The fuel is supplied from input port 52 and flows through accelerator chambers 54 that are designed to induce the siphon effect in passageway 26. The fuel is provided to chamber 50 and then passes through accelerator chambers 54 and is mixed with the air mixture through passageway 26. The diameter of chamber 54 is about 0.005 to about 0.05 inch, preferably about 0.010 to about 0.040 inch and more preferably about 0.037 inch. The air and fuel mixture exits venturi 38 at a higher velocity and volume than the air mixture that entered device 20. It is envisioned that chamber 50 is about 0.250 inches in diameter. The second stage includes the described amplification process and mixing process in venturi 38.

In a third stage, device 20 includes siphon barrel 60. The air and fuel mixture moves at the higher velocity v₃ from venturi 38 into siphon barrel 60. Siphon ports 74-siphon atmospheric air induced by higher velocity v₃ and the volume of air and fuel mixture from venturi 38 into body 68. The air and fuel mixture that was originally input to venturi 38 now has a much larger volume than initially supplied. In addition, since additional air is siphoned along passageway 26, the fluid flow is enriched with oxygen. This produces a clean, combustible fluid mixture able to sustain a continuous clean combustion in body 68. The diameter of passageway 26 is about ⅛ to about 1 inch, preferably about ¼ to about ¾ inch, and more preferably about ¼ inch. It is understood that the other passageways and bores in the present invention will be sized accordingly so as to correspond to the diameter of passageway 26.

Device 20 can be used in a variety of different machines, methods and manners. In cases where a large volume of air is required, the multiple-stage amplification and mixing device 20 can supply a much larger air volume than originally supplied to device 20. In addition, device 20 increases the velocity of fluid mixture that is generated from the exit ports of device 20 as well as the volume, as compared to the velocity of the fluid originally input to device 20. As discussed, in the case of combustible gases, device 20 allows for the mixing of the fuel with atmospheric air. By mixing with atmospheric air, the fluid stream is enriched with oxygen and therefore produces a higher temperature flame, which is easier to burn.

Device 20 can also be used as a torch. By adjusting the amount of fuel that enters the system, the heat energy produced can be controlled. That is, the flame at siphon barrel 60 can be made to burn at a higher temperature by increasing the amount of air flow into the system, and can be made to burn cooler by decreasing the amount of air flow into device 20. The velocity of fluid gases in chamber 68 decreases as pressure increases so that the flow remains about the same rate. The output velocity of the present invention is tuned by input parameters to match the combustion rate of the fuel source. For example, propane combustion rate burns at about 12 feet/sec, which is matched in the input parameters of air and propane. This is important in order to get full combustion. The velocity-exiting chamber 26 is more than 12 ft/sec and reduces to 12 ft/sec about midway through chamber 68 so that full combustion can occur. This also avoids back drafts.

Device 20 can be used as a single torch and, a pair of devices 20 can be used as a heating system. This heating system can be used in various fields such as powder coating to melt powder materials onto a substrate, welding, cooking and the like. One or more devices 20, as discussed below, may be mounted to a thermal spray powdered spray gun, such as, for example, the Xiom® 1000 g spray gun sold by Xiom Corporation located at West Babylon, N.Y. Torches employing device 20 impinge on the powder stream creating a compression point for adding supplementary heat to keep the powder particles melted while heating the substrate.

In another embodiment of the present invention, device 20 can be applied to existing thermal spray devices such as metal powder combustion, ceramic powder combustion, HVOF (High Velocity Oxy-Fuel), wire combustion, electric arc, and plasma spray guns.

For example, in another embodiment as shown in FIG. 10, a fluid amplification and mixing system adapted for use with a powder sprayer, such as, for example, a thermal powder spray gun torch adaptor 100 is provided. Torch adaptor 100 includes a pair of fluid amplification and mixing devices 20, similar to those described. Devices 20 are mounted to a bracket 102 with a powder sprayer 104 (see, for example, the Xiom® 10 g spray gun manufactured and sold by Xiom Corporation located at West Babylon, N.Y.), and spaced equidistantly thereapart. Powder sprayer 104 has a tip 106 defining an axis a and being configured to emit powder toward a substrate. Powder sprayer 104 is disposed adjacent devices 20.

Devices 20 provide combustion of an air and fuel mixture at a high velocity, similar to that discussed above, to generate a flame directed along axes x, y at an angle x₁, y₂, in a range of 8 to 90 degrees from axis a and the flame is spaced apart from the powder being emitted. In use, during spraying of powders, devices 20 may be used in heating of the substrate. During spraying, when the powder stream is emitted from sprayer 104 and crosses the hot air stream from devices 20, the spray pattern is larger. The powder also melts and flows uniformly. This unexpected phenomenon is due to the angle at which the flame from devices 20 are directed to the powder stream and the distance from the powder stream affected the width of the spray pattern as well as how well the powder melted.

Angles x, y, of approximately 30 degrees at a distance of 8 inches from tip 106 and about 5 inches to the side of the powder stream can be used on the substrate. Various degrees and distances from powder sprayer 104 can be used. For example, angles of about 8 degrees to about 90 degrees can be used. In addition, various positions of powder sprayer 104 can also be used. For example, powder sprayer 104 can be positioned from about 4 to about 12 inches away from the substrate to be sprayed. The substrate may include steel. Desirably, the flame from devices 20 can be positioned at about 30 degrees and the distance from the substrate is about 8 to 9 inches.

Disposing the powder emitted from powder sprayer 104 at about 8-9 inches from the flame advantageously results in several benefits, which include having the powder fan out and cover a larger surface area with a single stroke and, the flame, at 8-9 inches, has a reduced temperature of <1000° F. so as not to burn the plastic powder as it travels through the flame with an appropriate dwell time. As a result, the aforementioned system adaptor 100 sprays a powder layer that is thinly applied to the substrate. The results in an efficient use of powder, which does not scorch or exhibit striping.

Further, as a result of using devices 20 with powder sprayer 104, the powder coating thoroughly melts out, and is uniform and thin, with no visible signs of striping. Thermal set materials are also fully cured.

Adapter 100 incorporates devices 20 that impinge on the powder stream from both sides. This point of impingement allows the powder to fan out further and adds extra heat to the materials for efficient melting and curing. Adapter 100 advantageously avoids peeling, blistering, chipping and a pebble-like finish.

While in the foregoing, embodiments of this invention have been disclosed in considerable detail for purposes of illustration, those skilled in the art will realize that such details may be varied without departing from the spirit and scope of the invention.

What is claimed is:

1. A fluid amplification and mixing device comprising:
a siphon plug defining a first portion of a passageway being configured to receive a first fluid, the siphon plug further defines at least one opening configured to receive a second fluid in communication with the passageway;
a venturi defining a second portion of the passageway for receiving a mixture of the first and second fluids, the venturi further defining an input port configured to receive a third fluid and at least one accelerator chamber communicating with the input port and the second portion of the passageway; and
a siphon barrel defining a third portion of the passageway being configured to receive a mixture of the first, second and third fluids and supply the mixture to a combustion chamber thereof.

2. A fluid amplification and mixing device according to claim 1, wherein the siphon plug defines a plurality of openings configured to receive the second fluid.

3. A fluid amplification and mixing device according to claim 2, wherein the plurality of openings are circumferentially disposed about an outer surface of the siphon plug.

4. A fluid amplification and mixing device according to claim 1, wherein the siphon plug includes an inlet for receiving the first fluid at a first velocity, the inlet communicating with an accelerator that is configured to restrict the first fluid such that the first fluid exits at a second velocity greater than the first velocity.

5. A fluid amplification and mixing device according to claim 1, wherein the first fluid includes compressed air.

6. A fluid amplification and mixing device according to claim 1, wherein the second fluid is atmospheric air.

7. A fluid amplification and mixing device according to claim 1, wherein the accelerator chamber is configured to induce a siphon of the mixture of the first and second fluids received through an inlet of the venturi into a mixture of the first, second and third fluids such that the mixture of the first, second and third fluids exit the venture at a greater velocity.

8. A fluid amplification and mixing device according to claim 1, wherein the third fluid includes a combustible gas.

9. A fluid amplification and mixing device according to claim 1, wherein the venturi defines a plurality of accelerator chambers communicating with the input port and the second portion of the passageway.

10. A fluid amplification and mixing device according to claim 1, wherein the venturi defines a plurality of accelerator chambers, each separately and in parallel communicating with the input port and the second portion of the passageway.

11. A fluid amplification and mixing device according to claim 1, wherein the siphon barrel includes at least one port configured to receive atmospheric air.

12. A fluid amplification and mixing device according to claim 1, wherein the siphon barrel includes a plurality of ports configured to receive atmospheric air.

13. A fluid amplification and mixing device comprising:
a first stage including an accelerator configured to restrict a volume of compressed air input to the accelerator at a first velocity such that the air exits the accelerator at a second velocity greater than the first velocity;
a second stage including a venturi connected to the accelerator to receive the air at the second velocity in a mixture with an input gas supplied at a third velocity and amplify velocity of a mixture of the air and the input gas; and
a third stage including a siphon barrel configured to receive the mixture of the air and the input gas from the second stage for combustion thereof.

14. A fluid amplification and mixing device according to claim 13, wherein the first stage is configured to receive atmospheric air in a mixture with the air exiting the accelerator.

15. A fluid amplification and mixing device according to claim 13, wherein the venturi is configured to induce a siphon of the air received from the first stage into a mixture with the input gas including a fuel such that the mixture of the air and the fuel exits the venturi at an amplified velocity.

16. A fluid amplification and mixing device according to claim 15, wherein the fuel includes propane.

17. A fluid amplification and mixing device according to claim 13, wherein the siphon barrel is configured to receive atmospheric air in a mixture with the air and the input gas.

18. A fluid amplification and mixing system adapted for use with a powder sprayer comprising:
at least one fluid amplification and mixing device including:
a siphon plug defining a first portion of a passageway being configured to receive compressed air, the siphon plug further defines at least one opening configured to receive atmospheric air in communication with the passageway,
a venturi defining a second portion of the passageway for receiving the air mixture, the venturi further defining an input port configured to receive propane and at least one accelerator chamber communicating with the input port and the second portion of the passageway, and
a siphon barrel defining a third portion of the passageway being configured to receive a mixture of the air and propane and supply the mixture to a combustion chamber thereof to produce a flame; and
a powder sprayer having a tip defining an axis and being configured to emit powder toward a substrate, the powder sprayer being disposed adjacent the at least one fluid amplification and mixing device such that the flame is directed at an angle in a range of 8 to 90 degrees from the axis of the tip and the flame is spaced apart from the powder being emitted.

19. A fluid amplification and mixing system according to claim 18, further comprising a pair of fluid amplification and mixing devices mounted to bracket with the powder sprayer and spaced equidistantly there apart.

20. A fluid amplification and mixing system according to claim 18, wherein the flame is directed at an angle of 30 degrees from the axis of the tip.
